(19) United States
(12) Patent Application Publication
(10) Pub. No.: US 2012/0102458 A1
(43) Pub. Date: Apr. 26, 2012

(54) GENERATING DOCUMENTATION FROM TESTS

(75) Inventors: Erik Meijer, Mercer Island, WA (US); Dragos A. Manolescu, Kirkland, WA (US); John Wesley Dyer, Monroe, WA (US); Jeffrey Van Gogh, Redmond, WA (US)

(73) Assignee: Microsoft Corporation, Redmond, WA (US)

(21) Appl. No.: 12/909,851

(22) Filed: Oct. 22, 2010

(51) Int. Cl. G06F 9/44

(52) U.S. Cl. 717/123

(57) ABSTRACT

A documentation system is described herein that automatically generates documentation for software code from tests that verify the correct operation of the software code. Software development teams often write automated tests (software that tests the software being shipped), such as unit tests. When written correctly, these tests are a written contract of what the software is supposed to do. The documentation system can use static and dynamic analysis in combination with annotations in the test code to extract the contract from these tests and leverage the extracted information to automatically generate the documentation. The system can then visually display this information in a textual or graphical way. Thus, the documentation system generates documentation that more accurately reflects how software code is expected to operate, without introducing significant burdens into the software development cycle.

### BACKGROUND

Software documentation provides users and developers that interact with software code with information about how the code is designed to work. Documentation for an application programming interface (API) may inform developers about the parameters a method expects to receive, and the types of output provided by the method. In addition, documentation provides information about error conditions, exceptions that can be thrown by a method, and expected environment conditions for invoking the method. Environment conditions may include global variables that have been initialized, other methods that a developer is expected to call first, setup steps that are expected to be performed so that the method can execute successfully, and any other conditions that affect the outcome of invoking an API.

Several attempts have been made to improve software documentation, including automated methods for generating documentation. Most of these methods focus on generating documentation either from a product specification (e.g., from Unified Modeling Language (UML) descriptions of the software), or from the software code itself. Some programming languages and development tools allow developers to include marked up comments within the software code that other tools can extract to create documentation automatically. Such tools typically use static analysis of the software code to form a model of what the software code is doing that can be described through documentation.

Often, technical documentation is an area of the development process that does not get enough attention. Documentation is sparse, out of date, and frequently incorrect. In particular, corner case behavior is often ill defined. Reasons for these issues include: lack of resources, the product changes faster than the documentation writer can keep up, lack of communication between developers and documentation writers, not enough technical knowledge of the documentation writer, and so forth. Even automated tools are only as good as the input they receive. For example, automated tools that rely on software specifications may produce documentation that becomes out of date as the software changes if the specifications are not also maintained. Automated tools that generate documentation from the software code itself may handle common cases well, but are subject to errors in the software code or improper handling of errors that represent bugs in the software code and are not intended to be documented ways of using the software code. In addition, tools that rely on static analysis may fail to properly document dynamic conditions that occur when the software is actually executing.

### SUMMARY

A documentation system is described herein that automatically generates documentation for software code from tests that verify the correct operation of the software code. Software development teams often write automated tests (software that tests the software being shipped), such as unit tests. When written correctly, these tests are a written contract of what the software is supposed to do. The documentation system can use static and dynamic analysis in combination with annotations in the test code to extract the contract from these tests and leverage the extracted information to automatically generate the documentation. The system can then visually display this information in a textual or graphical way. Thus, the documentation system generates documentation that more accurately reflects how software code is expected to operate, without introducing significant burdens into the software development cycle.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the documentation system, in one embodiment.

FIG. 2 is a flow diagram that illustrates processing of the documentation system to automatically generate documentation describing application behavior from tests, in one embodiment.

FIG. 3 is a flow diagram that illustrates processing of the documentation system to gather information about application behavior from test code written to test the application, in one embodiment.

FIG. 4 is a flow diagram that illustrates processing of the documentation system to generate documentation from information gathered from test code, in one embodiment.

### DETAILED DESCRIPTION

A documentation system is described herein that automatically generates documentation for software code from tests that verify the correct operation of the software code. Software development teams often write automated tests (software that tests the software being shipped), such as unit tests. When written correctly, these tests are a written contract of what the software is supposed to do. The documentation system can use static and dynamic analysis in combination with annotations in the test code to extract the contract from these tests and leverage the extracted information to automatically generate the documentation. The system can then visually display this information in a textual or graphical way. Thus, the documentation system generates documentation that more accurately reflects how software code is expected to operate, without introducing significant burdens into the software development cycle.

When generating documentation from production code, it can be hard to determine the exact contract of the code. This is due in part to the vast space to explore, e.g., static analysis leverages powerful solvers that are expensive to run, but dynamic analysis will only discover information as the code is executed. Having developers put in annotations in the production code might be something that is too risky late in the game and can be expensive. Due to these constraints, it is a much safer idea to generate the documentation from test code. Good test code usually includes the corner cases, and describes the expected result (unlike production code, which often only reflects the correct result upon execution). It is also less risky to put in annotations late in the development cycle as test code usually does not ship, and having expensive annotations is less of an issue with respect to factors such as performance, code bloat, or intellectual property. As an example, consider the following example production code:

static void Reverse(byte[ ] source)
{

if (source == null)

throw new ArgumentNullException(“source”);

var length = source.Length;
var mid = length/2;
length--;
for(var i=0; i<mid; i++)
{

var tmp = source[i];
var other = length − i;
source[i] = source[other];
source[other] = tmp;

}

}

One common test for this type of code is to check the operation of a case in which a caller passes a null argument:

[TestMethod]
[ExpectedException(typeof(ArgumentNullException))]
public void CheckArguments( )
{

Reverse(null);

}

In this case, the system can use static analysis (either source or binary analysis) of the test code to extract the information the tester has written. The system can find out that the call to Reverse in this test has an argument of null by analyzing the method calls in the test. The system can find out that the expected outcome of this test is that an ArgumentNullException is thrown, by analyzing the attributes the tester put on the test code. From this information, the system can generate documentation describing that if this software code is called with a null value, an ArgumentNullException is to be expected.

When writing tests that are more complicated, it might become harder to use static analysis. For example, in the sample below, the static analysis would have to use a solver to see what is happening inside the for loop:

var original = new byte[ ] {1,2};
var input = original.ToArray( );
Reverse(input);
if (original.Length != input.Length)

throw new InvalidOperationException(“Arrays are not of

the same size”);

for (var i = 0; i < input.Length; i++)
{

if (original[i] != input[input.Length − 1 − i])

throw new InvalidOperationException(“Arrays was not

reversed correctly at position ” + i);

}

In this case, dynamic analysis might be more helpful. At runtime, dynamic analysis can track what inputs are passed to the Reverse method call, and record each index into the array afterwards. For example, if the input to Reverse is [1,2], the expected output is an array of the same length with values [2,1].

In order to extract details that are more specific from the tests, the system can use annotations. These can be either annotations already provided by the test framework to ease writing and debugging tests, or annotations provided for specific use with the documentation system. Consider the following example.

var original = new byte[ ] { };
var input = original.ToArray( );
Reverse(input);
Assert.AreEqual(original.Length, input.Length);
for (var i = 0; i < input.Length; i++)
{

Assert.AreEqual(original[i], input[input.Length − 1 − i]);

}

Here the test specifically identifies what post conditions are expected to hold through assertions. These annotations can be used to write stronger contracts than the system might infer with static or dynamic analysis alone. The documentation system can build knowledge of annotations provided by the test framework, provide its own set of annotations, or allow the test writer to define custom annotations. The tester can then teach the documentation system how to interpret these custom annotations, such as through a registration and description process.

Another way to make it easier to generate documentation from the tests is to write the tests in a specific way so that it is easier for the documentation system to generate the documentation from the tests. Often this is by writing the tests in a more declarative way. For example, the test code can be parameterized as follows.

class TestDetails
{

public byte[ ] Input { get; set; }
public byte[ ] ExpectedResult { get; set; }
public Type ExpectedException { get; set; }

}
static void ReverseTests(TestDetails[ ] details)
{

foreach (var detail in details)
{

var input = detail.Input.ToArray( );
try
{

Reverse(input);

}
catch(Exception e)
{

if (detail.ExpectedResult != null ||

detail.ExpectedException == null)

throw new InvalidOperationException(“Reverse

threw exception, but results were expected”);

if (e.GetType( ) != detail.ExpectedException)

throw new InvalidOperationException(“Exception

of type ” + detail.ExpectedException.FullName +“ was expected, but
encountered an exception of type ” + e.GetType( ).FullName);

return;

}
if (detail.ExpectedException != null)

throw new InvalidOperationException(“An exception

of type ” +detail.ExpectedException.FullName + “was expected, but no
exception occured.”);

Assert.AreEqual(detail.ExpectedResult.Length,

input.Length);

for (var i = 0; i < input.Length; i++)
{

Assert.AreEqual(detail.ExpectedResult[i],

input[i]);

}

}

}

Now the tester can write input-output conditions declaratively as follows.

private TestDetails[ ] GetTests( )
{

return new[ ]
{

new TestDetails
{

Input = new byte[ ] { },
ExpectedResult = new byte[ ] { },

},
new TestDetails
{

Input = null,
ExpectedException = typeof(ArgumentNullException),

},
new TestDetails
{

Input = new byte[ ] { 1 },
ExpectedResult = new byte[ ] { 1 },

},
new TestDetails
{

Input = new byte[ ] { 1, 2 },
ExpectedResult = new byte[ ] { 2, 1 },

},
new TestDetails
{

Input = new byte[ ] { 2, 1 },
ExpectedResult = new byte[ ] { 1, 2 },

},
new TestDetails
{

Input = new byte[ ] { 3, 1, 2 },
ExpectedResult = new byte[ ] { 2, 1, 3 },

}

};

}

In this case, it becomes easier to extract the tests from the code, as the extraction tool can call this method and iterate over all the information returned. The system may include a custom bridge between the test and the documentation generator to create a way to parse the information.

As shown previously the system can use the information extracted from tests to generate textual documentation. The system can then use this rich information to generate various types of documentation, including graphical documentation. Graphical documentation can often help explain complex issues as many people learn quicker from visual information than from textual information. For example, the declarative test code:

{

Input = new byte[ ] { 1, 2 },
ExpectedResult = new byte[ ] { 2, 1 },

},

could be documented with the following text, “when Reverse is passed the array [1,2] the expected output is the array [2,1],” or it could be documented with a visual representation, such as “{1 2}->{2 1}.” The system can use different colors representing input and output, visually represent each input in blocks, or any other helpful visual indicator to convey the information.

As now (more of) the documentation can be generated, this makes it easier to keep the documentation up-to-date as the product changes. This will close the loop in the software lifecycle, as it is now easier for users to give feedback on the product based on the up-to-date documentation mode quickly. In addition, as missing documentation is identified, so too are missing test cases. Thus, as the product documentation improves so too does the robustness of the product itself.

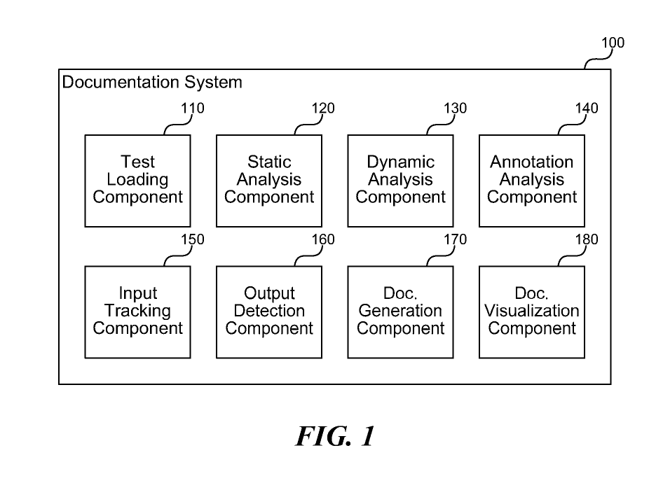

FIG. 1 is a block diagram that illustrates components of the documentation system, in one embodiment. The system 100 includes a test loading component 110, a static analysis component 120, a dynamic analysis component 130, an annotation analysis component 140, an input tracking component 150, an output detection component 160, a documentation generation component 170, and a documentation visualization component 180. Each of these components is described in further detail herein.

The test loading component 110 receives software test code from which to extract input and expected output information describing expected behavior of a software application. For example, documentation writer may run a tool that implements the system 100 and provide the tool with a directory or other specification of a location containing test code. The tool may provide a command-line interface (CLI), graphical user interface (GUI), or programmatic API through which the writer can specify the location of test code. The test code may include one or more unit tests or other tests for verification the correct operation of the software application. The test code may implicitly describe expected inputs and resulting outputs of the software application, and may include explicit indications of the same, such as through annotations or declarative indications.

The static analysis component 120 performs analysis on the received software test code by examining the code without executing the code to identify declared behavior of the test code. For example, static analysis can determine variables, movement of data, inputs passed to a called function, outputs tested for from the called function, and other useful information just by examining the code itself. Static analysis can be performed on software code in a programming language, such as C++ or C#, or in a binary executable format or intermediate code (e.g., MICROSOFT™ Intermediate Language (IL)). Those of ordinary skill in the art will recognize numerous available tools and techniques for performing static analysis on software code.

The dynamic analysis component 130 performs analysis on the received software test code by examining the code while the code is executing to identify run-time behavior of the test code. For example, the component 130 may execute the test code within a virtual machine or by injecting one or more software hooks into the test code so that the component 130 can monitor values placed in one or more variables, registers, or other storage locations. Dynamic analysis can follow data movement and results that may not be readily apparent or definite from a static analysis of the received test code. Dynamic analysis allows the system 100 to discover additional expected behavior of the software application. The system 100 may combine static and dynamic analysis to learn more information from the software test code.

The annotation analysis component 140 identifies annotations within the received software test code that provide information about expected input and output from the software application. For example, a test developer may place attributes on test code, use a predetermined commenting format, use debugging aids such as assertions, or other annotations that provide information about expectations of the test code. The expectations of the test code often provide a useful view of acceptable behavior of the software application under test. In some embodiments, the system 100 allows test developers to provide custom annotations and teach new annotation meanings to the annotation analysis component 140 so that further information can be conveyed from the test code to the system 100.

The input tracking component 150 combines the results of any static analysis, dynamic analysis, and annotation analysis to identify and track one or more input values that the test code provides the software application. Input values going into the software application produce particular expected output values. By tracking the input values, the component 150 can match the tracked inputs to the resulting outputs received from the software applications. Inputs may include the base knowledge that a particular function was called, as well as additional information such as parameters passed to the function, environmental data set up before the function was called, and so forth. Anything that may affect the received output can be considered an input value that the system 100 may track. When producing documentation, the system 100 describes the relationships between input and output values for a particular API.

The output detection component 160 detects one or more expected output values that result from the input values provided by the test code to the software application. Output values are typically checked by the software test code, and through static analysis, dynamic analysis, and annotation analysis, the system 100 can determine which output values are expected by the test code for any particular invocation of the software application. The component 160 associates detected output values with the input values that produced them so that generated documentation can describe any identified relationship between inputs and expected outputs. Output values may include return values, return parameters, exceptions, modifications to environmental data, and any other result produced by invoking the application.

The documentation generation component 170 generates documentation describing behavior of the software application based on the identified input and output values discovered by the system 100. For example, the component 170 may produce a table that describes each input value in a row and the expected output value produced by that input in the same row. Because tests often focus on edge/corner cases that may be useful for developers using a particular API, using the tests to produce documentation means that such cases will be well documented and developers will be less likely to use the API in an unexpected way. The documentation generation component 170 may store intermediate documentation information in a form from which other tools can generate various forms of documentation, including text-based (e.g., Hypertext Markup Language (HTML)), graphical (e.g., charts or other visual depictions), and so on.

The documentation visualization component 180 produces documentation that visually illustrates behavior of the software application based on the identified input and output values discovered by the system. The component 180 may operate on intermediate documentation information output by the documentation generation component 170 or may directly invoke the other components to analyze the software test code and produce visual documentation. The visual documentation may include block diagrams, flow diagrams, charts, graphs, or any other helpful visual aid for describing behavior of the software application as reflected in the received software test code.

The computing device on which the documentation system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

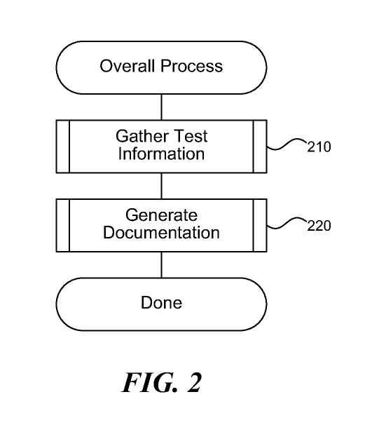

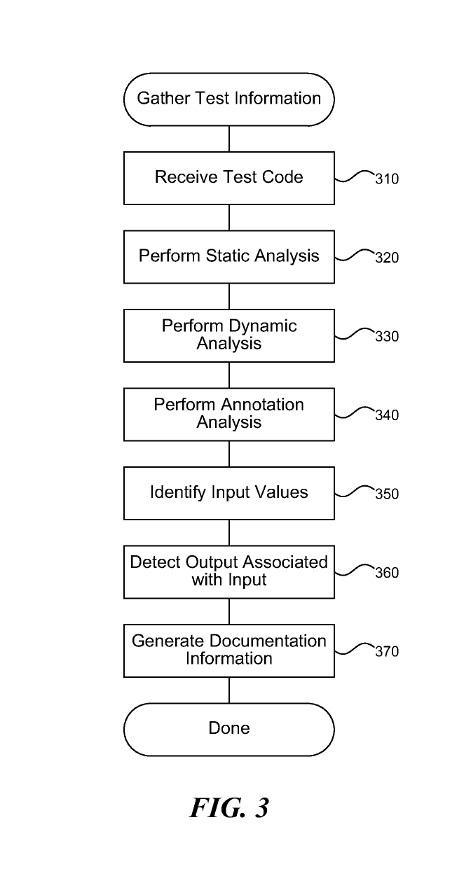

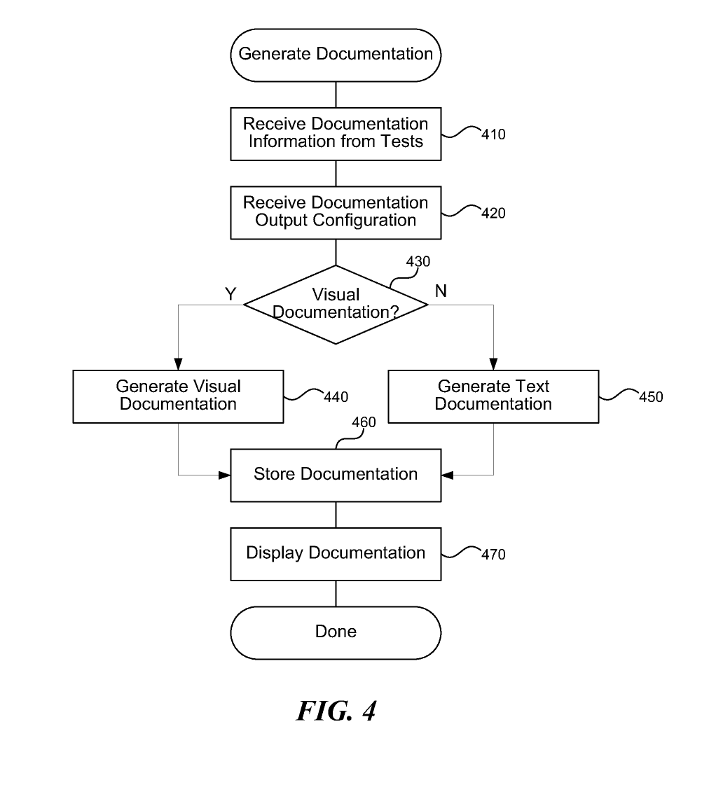

FIG. 2 is a flow diagram that illustrates processing of the documentation system to automatically generate documentation describing application behavior from tests, in one embodiment. Beginning in block 210, the system gathers information from test code that describes expected application behavior. For example, the system may perform a variety of static, dynamic, and annotation analysis on test code to identify expected input and output values of the application. This process is described further with reference to FIG. 3. Continuing in block 220, the system generates documentation based on the gathered information. For example, the system may produce HTML or other output that can be provided as a web page or Compiled HTML (CHM) help format. This process is described further with reference to FIG. 4. After block 220, these steps conclude.

FIG. 3 is a flow diagram that illustrates processing of the documentation system to gather information about application behavior from test code written to test the application, in one embodiment. Beginning in block 310, the system receives test code that performs one or more tests to verify behavior of a software application. For example, the system may receive input information identifying a storage location of the test code. Upon receiving the location, the system may load each test file into memory and invoke the static analysis and other components described herein to analyze the test code and discover information about the application that the code tests. Because test code often includes detailed information about expected results from the application for given inputs, the system extracts useful information from the test code.

Continuing in block 320, the system performs static analysis on the received test code to identify application behavior information embedded within the test code. For example, the system may identify input variable values, expected output results, one or more corner cases that the application is expected to handle, and so forth. Static analysis can parse source code to identify one or more purposes of the code or can disassemble and interpret binary code intended for particular hardware. In some embodiments, the system may encourage test writers to format test code in a manner that allows easier extraction of information about application behavior. For example, the system may provide a declarative format that test writers can use to make test code easy to interpret.

Continuing in block 330, the system runs the test code to dynamically analyze the running test code and identify application behavior information that was not available through static analysis. For example, the system may monitor registers, memory locations, and other storage locations for values of variables that are dynamically set and difficult to identify using static analysis. The system may monitor input values, associated output results, interaction patterns between program components/modules, and communication profiles as one or more application APIs are invoked by the test code.

Continuing in block 340, the system optionally analyzes the test code for annotations that provide additional information about expected behavior of the software application. For example, the annotations may highlight pre- and post-conditions that are difficult to detect by analyzing the test code alone. Annotations can also identify invariant properties of the application that are expected to hold true under a variety of test circumstances. In some embodiments, the system may provide a default set of annotations that testers can place in the test code to pass information to the system. In some embodiments, the system may receive custom annotations from test authors that provide application-specific information to the system.

Although shown serially for ease of illustration, in some cases the system may perform each type of analysis in parallel or may perform various combinations of analysis (e.g., static analysis with annotation analysis) to make the system operate efficiently and to provide more information for generating documentation.

Continuing in block 350, the system identifies input values detected through static, dynamic, and annotation analysis and stores identified input values for association with detected output results. For example, the system may detect that one test passes a null value to an application API and expects a particular result in response. Continuing in block 360, the system detects output associated with the identified input values. Static or annotation analysis may directly reveal an association between a given input value and an expected output result. Dynamic analysis may detect input values or output results that are not easily discoverable through static analysis. As the test code executes, the system detects output values at runtime and stores information about the input values that caused particular output results.

Continuing in block 370, the system generates documentation information that describes behavior of the software application based on expected associations between input values and output results in the test code. The system may store the documentation information in an intermediate format from which other tools can generate documentation in a variety of formats (see FIG. 4). Alternatively or additionally, the system may directly output documentation following the preceding steps. After block 370, these steps conclude.

FIG. 4 is a flow diagram that illustrates processing of the documentation system to generate documentation from information gathered from test code, in one embodiment. Beginning in block 410, the system receives documentation information derived from test code that tests behavior of an application, wherein the documentation information describes one or more input values and associated output results expected upon invoking the application. For example, the system may load information stored following a process like that described with reference to FIG. 3. The system may provide a tool that a documentation writer can invoke to load information derived from test code and then generate one or more forms of documentation for release to users of the application.

Continuing in block 420, the system receives document output configuration that specifies at least a type of documentation to generate based on the received documentation information. For example, the tool may provide options for generating text-based documentation in one or more available formats (e.g., HTML, extensible markup language (XML), a proprietary help format, and so forth). The tool may also provide options for graphical or mathematical documentation.

Continuing in decision block 430, if the configuration specified visual documentation, then the system continues at block 440, else the system continues at block 450. Continuing in block 440, the system generates visual documentation that visually depicts application behavior. For example, the system may produce a visual data flow diagram that shows how particular input flows into the application and results in particular output values. The system may also produce a graph, timeline, or other chart that visually displays information about the application to the user. In some embodiments, the system may produce animations that show data flows, state diagrams, or other information.

Continuing in block 450, the system generates textual documentation that describes application behavior. For example, the system may output one or more tables of input values and expected output, or may produce sentences that describe how the application works based on the documentation information extracted from the test code. Although shown separately, in some cases the system may generate a combination of textual and visual documentation at the same time or as part of the same pass.

Continuing in block 460, the system stores the generated documentation for subsequent distribution to users of the application. For example, the system may output a website in HTML or a help file (e.g., HLP or CHM file) that can be shipped with a software product or made available online so that users can refer to the documentation when using the product or invoking APIs exposed by the product for extensibility. Continuing in block 470, the system displays the stored documentation to a user. For example, the user may visit a website that serves the documentation to a client browser through a web server or the user may load a help viewing application on a local client that allows the user to view one or more help file formats. These tools render the stored documentation textually or graphically to the user so that the user can learn about the application behavior. After block 470, these steps conclude.

In some embodiments, the documentation system operates in an ongoing product lifecycle. For example, a developer may create or modify product code, a tester may create or modify test code, a documentation writer may generate documentation from the test code, and users may give feedback based on the latest documentation. The user feedback starts the cycle again, where the developer modifies the product code based on the user's feedback, the tester updates tests, the documentation writer updates the documentation, and the product improves over time along this cycle.

From the foregoing, it will be appreciated that specific embodiments of the documentation system have been described herein for purposes of illustration, but that various modifications may be made without deviating from the spirit and scope of the invention. Accordingly, the invention is not limited except as by the appended claims.

I/We claim:

1. A computer-implemented method for gathering information about application behavior from test code written to test the application, the method comprising:
receiving test code that performs one or more tests to verify behavior of a software application;
performing static analysis on the received test code to identify application behavior information embedded within the test code;
running the test code to dynamically analyze the running test code and identify application behavior information that was not available through static analysis;
identifying input values detected through static or dynamic analysis and storing identified input values for association with detected output results;
detecting output associated with the identified input values;
generating documentation information that describes behavior of the software application based on expected associations between input values and output results in the test code,
wherein the preceding steps are performed by at least one processor.

2. The method of claim 1 wherein receiving test code comprises receiving input information identifying a storage location of the test code.

3. The method of claim 1 wherein performing static analysis comprises parsing source code to identify one or more purposes of the code.

4. The method of claim 1 wherein performing static analysis comprises disassembling and interpreting binary code intended for particular hardware.

5. The method of claim 1 wherein performing static analysis comprises analyzing test code formatted in a declarative manner that allows easier extraction of information about application behavior.

6. The method of claim 1 wherein running the test code comprises monitoring at least one of registers, memory locations, state transitions, database records, events, user interface elements, or other storage locations for values of variables that are dynamically set and difficult to identify using static analysis.

7. The method of claim 1 wherein running the test code comprises monitoring input values and associated output results as one or more application methods are invoked by the test code.

8. The method of claim 1 further comprising analyzing the test code for annotations that provide additional information about expected behavior of the software application.

9. The method of claim 8 further comprising providing a default set of annotations that testers can place in the test code to pass information describing expected application behavior.

10. The method of claim 8 further comprising receiving custom annotations from test authors that provide application-specific information describing expected application behavior.

11. The method of claim 1 wherein detecting output comprises using static or annotation analysis to detect an association between a given input value and an expected output result.

12. The method of claim 1 wherein detecting output comprises using dynamic analysis to detect input values or output results at runtime.

13. A computer system for generating documentation from tests, the system comprising:
a processor and memory configured to execute software instructions embodied within the following components;
a test loading component configured to receive software test code from which to extract input and expected output information describing expected behavior of a software application;
a static analysis component configured to perform analysis on the received software test code by examining the code without executing the code to identify declared behavior of the test code;
a dynamic analysis component configured to perform analysis on the received software test code by examining the code while the code is executing to identify run-time behavior of the test code;
an annotation analysis component configured to identify annotations within the received software test code that provide information about expected input and output from the software application;
an input tracking component configured to combine the results of any static analysis, dynamic analysis, and annotation analysis to identify and track one or more input values that the test code provides the software application;
an output detection component configured to detect one or more expected output values that result from the input values provided by the test code to the software application; and
a documentation generation component configured to generate documentation describing behavior of the software application based on the identified input and output values discovered.

14. The system of claim 13 wherein the test loading component is further configured to receive test code that implicitly describes expected inputs and resulting outputs of the software application.

15. The system of claim 13 wherein the test loading component is further configured to receive test code that includes explicit indications of expected inputs and resulting outputs of the software application through annotations or declarative indications.

16. The system of claim 13 wherein the static analysis component is further configured to determine at least one of variables, movement of data, inputs passed to a called function, outputs tested for from the called function, and escape conditions.

17. The system of claim 13 wherein the dynamic analysis component is further configured to execute the test code within a virtual machine or inject one or more software hooks into the test code so that the component can monitor values placed in one or more variables, registers, or other storage locations.

18. The system of claim 13 wherein the output detection component is further configured to associate detected output values with the input values that produced them so that generated documentation can describe any identified relationship between inputs and expected outputs.

19. The system of claim 13 further comprising a documentation visualization component configured to produce documentation that visually illustrates behavior of the software application based on the identified input and output values discovered by the system.

20. A computer-readable storage medium comprising instructions for controlling a computer system to generate documentation from information gathered from test code, wherein the instructions, upon execution, cause a processor to perform actions comprising:
receiving documentation information derived from test code that tests behavior of an application, wherein the documentation information describes one or more input values and associated output results expected upon invoking the application;
receiving document output configuration that specifies at least a type of documentation to generate based on the received documentation information;
generating textual or visual documentation based on the received output configuration, wherein visual documentation visually depicts application behavior;
storing the generated documentation for subsequent distribution to users of the application; and
displaying the stored documentation to a user.
